(19) United States
(12) Patent Application Publication
(10) Pub. No.: US 2005/0091440 A1
(43) Pub. Date: Apr. 28, 2005

(54) Memory system and memory module

(75) Inventors: Satoshi Isa, Tokyo (JP); Toshio Sugano, Tokyo (JP); Wataru Kikuchi, Tokyo (JP)

Correspondence Address: Norman P. Soloway;HAYES SOLOWAY P.C., 130 W. Cushing Street, Tucson, AZ, 85701, US

(73) Assignee: ELPIDA MEMORY INC.

(21) Appl. No.: 10/973,961

(22) Filed: Oct. 26, 2004

(30) Foreign Application Priority Data
Oct. 28, 2003 (JP) 2003-367373

(51) Int. Cl. G06F 12/00

(52) U.S. Cl. 711/1

(57) ABSTRACT

To increase data transfer rate of a memory system in which a plurality of memory modules are stacked using mezzanine connectors, stacked blind vias and buried vias for connecting only specific layers are used as vias in a multilayer circuit board serving as a memory module board, and at least some of pads for mounting devices have a pad-on-via structure. Thus, the vias have no redundant portions which are not required for signal transmission and the length of surface-layer wiring can be remarkably reduced.

### BACKGROUND OF THE INVENTION

1. Field of the Invention

The present invention relates to memory systems and, more particularly, to a memory module including (female and/or male) mezzanine connectors attached to a module board in order to stack a plurality of memory modules on a motherboard, and a memory system using the same.

2. Description of the Related Art

Memory systems in each of which a memory controller is connected to memories via transmission lines include a memory system using a double data rate synchronous DRAM (DDR-SDRAM). This memory system will be referred to as a DDR memory system below. In the DDR memory system, a data signal is bidirectionally transferred between the memory controller and each memory at a data transfer rate that is twice as high as a clock frequency. On the other hand, a command signal indicating a read or write mode or an address signal indicating an address related to access is transferred from the memory controller to the memory in only one direction at a data transfer rate that is the same as the clock frequency, namely, at a data transfer rate that is ½ that of the data signal.

One of bus connection techniques for realizing the DDR memory system is an interface technique called stub series terminated logic (SSTL). FIG. 9 is a schematic diagram of the structure of a conventional DDR memory system according to the SSTL interface. This system will be referred to as a first conventional system below. In the first conventional system, a command and address bus and a data bus are arranged according to the SSTL interface,

Referring to FIG. 9, the memory system includes: a motherboard 900; a plurality of memory modules (below, abbreviated to modules) 920 and 921, each of which a plurality of memories 910 are mounted in; a plurality of connectors 950 for connecting the modules 920 and 921 to the motherboard 900; a memory controller 901 having a mechanism of controlling the memories 910; a data bus 940 including a plurality of lines with stubs; and an address and command bus 930 similarly including a plurality of lines with stubs; and a plurality of resistance elements (stub resistors) 960 for suppressing the generation of reflected signal interference.

FIG. 10 shows a memory system (below, referred to as a second conventional system) according to an interface technique for realizing higher bus data transfer rate than that according to the SSTL interface. This system is disclosed in, for example, Japanese Unexamined Patent Application Publication No. 2001-256772 (Patent Document 1), of which FIGS. 21A and 21B show a concrete example of the system. This interface has no common name. In the present description, for the sake of convenience, the interface will be called a stub less terminated logic (SLT) interface below.

Referring to FIG. 10, the memory system includes: a motherboard 1000: a plurality of modules 1020 and 1021, each of which a plurality of memories 1010 are mounted in; a plurality of connectors 1050 for connecting the modules 1020 and 1021 to the motherboard 1000; a memory controller 1001; termination resistors (not shown) which are arranged at the respective ends of transmission lines and are connected to an appropriate termination voltage Vtt, the ends being the farthest from the memory controller 1001; an address and command bus 1030; and a data bus 1040 including single-stroke lines with no stubs.

According to the second conventional system, the command and address bus 1030 is arranged according to the SSTL interface in the same way as the system of FIG. 9 and the data bus 1040 is arranged according to the SLT interface.

Referring to FIG. 10, the data bus 1040 extending from the motherboard 1000 is connected to the memories 1010 in the module 1020 through the connector 1050 and is then again connected to the motherboard 1000 via the connector 1050. The data bus 1040 is then connected to the memories in the other module 1021 via the other connector 1050. As mentioned above, since the data bus 1040 includes single-stroke lines, ideally, the transmission lines have no stubs. Further, impedance matching is obtained in the vicinity of the memories 1010 in the same way as in a lumped constant circuit. Thus, signal reflection can be remarkably reduced as compared with the case where the data bus 940 is arranged according to the SSLT interface as shown in FIG. 9. Consequently, the transfer rate of the data bus according to the SLT interface can be higher than that according to the SSTL interface.

An interface technique for realizing higher bus data transfer rate than that according to the SLT interface is called point-to-point (below, referred to as a P2P interface). FIG. 11 shows the structure of a conventional memory system (below, referred to as a third conventional system) according to the P2P interface. In the third conventional system, a command and address bus and a data bus are arranged according to the P2P interface.

Referring to FIG. 11, the memory system includes, a motherboard 1100; a memory controller 1101; modules 1120 and 1121 each of which a register 1102 and a plurality of memories 1110 are mounted in; and connectors 1150 for connecting the modules 1120 and 1121 to the motherboard 1100; address and command buses 1130 and 1131; and data buses 1140 and 1141. The memory controller 1101 is connected to the register 1102 on the module 1120 in a one-to-one relationship through the address and command bus 1130 including a plurality of lines with no stubs. The memory controller 1101 is connected to each of the memories 1110 in the module 1120 in a one-to-one relationship via the data bus 1140 including a plurality of lines with no stubs. Similarly, the memory controller 1101 is connected to the register 1102 in the module 1121 in a one-to-one relationship through the address and command bus 1131 including a plurality of lines with no stubs. The memory controller 1101 is also connected to each of the memories 1110 in the module 1121 in a one-to-one relationship through the data bus 1141 including a plurality of lines with no stubs.

According to the P2P interface, load is small and impedance matching is easily obtained. Therefore, signal attenuation or reflection can be greatly reduced as compared with the above-mentioned cases according to the SSTL and SLT interfaces. Thus, the highest data bus transfer rate is obtained.

The combination of the address and command bus 1130 and the data bus 1140 and the combination of the address and command bus 1131 and the data bus 1141 are generally called channels. Those channels permit data input/output independently of each other. According to the P2P interface, since a plurality of channels are provided, the data transfer rate is higher than that in a single-channel arrangement, i.e., the arrangement of each of the first and second conventional systems.

FIG. 12 shows a further another conventional memory system (fourth conventional system). In the fourth conventional system, command and address buses and data buses are arranged according to the P2P interface.

Referring to FIG. 12, the memory system includes: a motherboard 1200; a memory controller 1201; modules 1220 and 1221 each of which a buffer 1203 and a plurality of memories 1210 are mounted in; and connectors 1250 for connecting the modules 1220 and 1221 to the motherboard 1200; and a bus assembly 1270 composed of a plurality of address and command buses with no stubs and a plurality of data buses with no stubs. The memory controller 1201 is connected to the buffer 1203 on the module 1220 in a one-to-one relationship through the bus assembly 1270 and the buffer 1203 on the module 1220 is similarly connected to that on the module 1221 in a one-to-one relationship through the bus assembly 1270, thus transferring signals therebetween.

In the above system, the buffers 1203 supply address signals and command signals to the memories 1210 in the respective modules 1220 and 1221 and also supply data signals thereto. Therefore, each memory 1210 does not need to realize the same data transfer rate as that of the memory controller 1201. In other words, it is sufficient that only the buffer 1203 should realize high data transfer rate that is the same as that of the memory controller 1201. Accordingly, data transfer can be performed at higher rate.

In each of the above-mentioned conventional systems, a part (one end, namely, one edge) of each module is inserted into the corresponding connector mounted on the motherboard to electrically connect the module to the motherboard. Accordingly, card edge connectors are used. In the case where the connectors are mounted on the motherboard in a one-to-one relationship with the modules, disadvantageously, as the number of modules is increased, the mounted area on the motherboard is also increased. FIG. 13 shows a memory system which overcomes the above disadvantage. This system, which is not a DDR memory system, is disclosed in, for example, Japanese Unexamined Patent Application Publication No. 2000-31617 (Patent Document 2), of which FIG. 1 shows an example of the arrangement of memory modules.

In the memory system in FIG. 13, a male connector 1350 is mounted on a motherboard 1300 and another male connector 1352 is mounted on the upper surface of a module 1320. A female connector 1351 is mounted on the lower surface of the module 1320 and another female connector 1353 is mounted on the lower surface of a module 1321. The female and male connectors 1350 and 1351 are connected to each other, so that the motherboard 1300 is electrically connected to the module 1320. Similarly, the module 1320 is connected to the module 1321 via the male and female connectors 1352 and 1353. In this connection pattern, a plurality of modules can be stacked parallel to each other on the motherboard. Advantageously, the mounted area on the motherboard of the memory system can be remarkably reduced as compared with the memory system using the card edge connectors, through which the modules are mounted on the motherboard such that the modules are perpendicular to the motherboard.

When each of the above-mentioned bus connection techniques such as the SSTL, SLT, and P2P interfaces is applied to a connection pattern using mezzanine connectors, therefore, the reduction in size of a memory system may be accomplished.

To mount mezzanine connectors on memory modules, it is necessary to install wiring corresponding to the connectors on each module board. In other words, it is necessary to provide pads for connecting the connectors on the upper and lower surfaces of the module board and install the wiring to connect the pads to the corresponding pads on the upper and lower surfaces. Regarding the module board, a multilayer printed circuit board having through holes is available.

It is known that the multilayer printed circuit board having through holes has a disadvantage in that it requires special areas to form through holes. Techniques for overcoming the above disadvantage include an approach using interstitial via holes. This approach is disclosed in, for example, Japanese Unexamined Patent Application Publication No. 10-13028 (Patent Document 3), of which FIG. 2 shows an example of a printed circuit board according to this approach.

Connection patterns using mezzanine connectors according to the SSTL, SLT, and P2P interfaces will now be described below.

FIGS. 14A and 14B show an example of a memory system (below, referred to as a first related art) realized by applying the SSTL interface to a connection pattern using mezzanine connectors.

Referring to FIGS. 14A and 14B, a mezzanine connector (male connector) 1450 is provided on a motherboard 1400 having a memory controller 1401. A female connector 1451 is provided on the lower surface of a memory module 1420. A male connector 1452 is provided on the upper surface thereof so as to correspond to the connector 1451, with the module board therebetween. Further, a female connector 1453 is provided on the lower surface of a memory module 1421. The male connector 1450 on the motherboard 1400 is engaged with the female connector 1451 on the lower surface of the memory module 1420 and the male connector 1452 on the upper surface of the memory module 1420 is engaged with the female connector 1453 on the lower surface of the memory module 1421, so that the memory modules 1420 and 1421 are attached to the motherboard 1400 such that the modules are stacked on the motherboard. An arrangement in which the memory controller 1401 is connected to each memory 1410 through a command and address bus 1430 and a data bus 1440 and a stub resistor 1460 is provided for each line of the respective buses is the same as that of the memory system in FIG. 9.

FIG. 15 shows the layer configuration of each memory module board used in the first related art.

Referring to FIG. 15 the memory module board includes six layers, i.e., a signal layer L1 (below, referred to as a first layer L1), a power-supply/ground layer L2 (second layer L2), a signal layer L3 (third layer L3), a signal layer L4 (fourth layer L4), a power-supply/ground (GND) layer L5 (fifth layer L6), and a signal layer L6 (sixth layer L6). In this case, it is assumed that the data bus is arranged using the inner layers (third and fourth layers L3 and L4). The width of each line in the power supply/GND layers and the thicknesses of the respective dielectric layers L0 are adjusted so that the characteristic impedance of each line indicates a predetermined value (for example, 60 ohms).

FIGS. 16A to 16C show the wiring layout of the data bus in a region 1420a in the vicinity of the connectors on the module 1420 in FIG. 14B. FIG. 16A is a top view of the wiring layout, FIG. 16B is a side view thereof, and FIG. 16C is a perspective view thereof, To make the layout easier to understand, the dielectric layers L0 and the power-supply/GND layers L2 and L5 are not shown in FIGS. 16A to 160. Arrows in FIGS. 16B and 160 denote examples of signal transmission routes.

The relationship between the components in FIGS. 14A, 14B, 15, and 16A to 16C will now be described in brief. The mezzanine connectors 1451 and 1452 and the stub resistors 1460 in FIGS. 14A and 14B are arranged in the surface layers (first and sixth layers L1 and L6) in FIG. 15. Pads 16p1-L1, 16p1-L6, 16p2-L1, and 16p2-L6 for mounting the above components are shown in FIGS. 16A to 16C. The data bus 1440 in the module 1420 in FIGS. 14A and 14B mainly includes the inner layers (third and fourth layers L3 and L4) in FIG. 15. The data bus in the inner layers is shown by wiring patterns 16s1-L3 and 16s1-L4 in FIGS. 16A to 16C. Regarding the connector mounting pads 16p1-L1 and 16p1-L6, two rows of pads 16p1-L1 are arranged in the upper surface of the module and two rows of pads 16p1-L6 are arranged in the lower surface thereof. The same signal is supplied to the upper and lower mounting pads corresponding to each other on the upper and lower surfaces.

Referring to FIG. 14B, the data bus 1440 in the motherboard 1400 is connected to the mounting pads 16p1-L6 in the sixth layer L6 in the module 1420 via the mezzanine connectors 1450 and 1451. The data bus 1440 is then branched into two sets of lines. Referring to FIGS. 16B and 16C, one set of lines are connected to the mounting pads 16p1-L1 in the first layer L1 and the other one set of lines are connected to the stub resistor mounting pads 16p2-L1 in the first layer L1 or the stub resistor mounting pads 16p2-L6 in the sixth layer L6. Lines connecting the mezzanine connector mounting pads to the stub resistor mounting pads are realized by the wiring patterns 16s1-L3 and 16s1-L4 in the inner layers L3 and L4 in FIG. 15. Lines extending from the stub resistor mounting pads 16p2-L1 and 16p2-L6 to the respective memories 1410 are also realized by the wiring patterns 16s1-L3 and 16s1-L4 in the inner layers L3 and L4.

According to the first related art, regarding vias for interlayer connection in the module board, through-hole type vies are used. The through-hole type via is formed by drilling a hole in all the layers of the module board and then plating the inner surface of the hole. Thus, the hole is hollowed. Therefore, the mounting pads 16p1-L1, 16p1-L6. 16p2-L1, and 16p2-L6 cannot be arranged directly on power-supply/GND connection vias 16t0 and signal connection vias 16t1. It is necessary to arrange the mounting pads separately from the vias. Referring to FIGS. 16A to 16C, the vias 16t0 are used for power-supply/GND connection and the vias 16t1 are used for signal connection. Moreover, it is necessary to arrange the wiring patterns 16s1-L3 and 16s1-L4 in the inner layers L3 and L4 such that each line passes between the vias in order to reduce the size of the module board. Accordingly, it is necessary to provide a proper space between the vias.

For this reason, therefore, the first related art requires regions 16a10, 16a11, 16a20, 16a21, and 16a22 necessary for the arrangement of the vias and the wiring patterns as shown in FIG. 16A.

Referring to FIGS. 16B and 16C, the vias formed in the regions 16a20, 16a21, and 16a22 for the stub resistor mounting pads 16p2-L1 and 16p2-L6 include redundant portions 16a30 and 16a31, which are not needed for signal transmission.

FIGS. 17A to 17C show the wiring layout of the data bus in a region 1420b in the vicinity of the memories in FIG. 14B.

FIG. 17A is a top view of the wiring layout of the data bus, FIG. 17B is a side view thereof, and FIG. 17C is a perspective view thereof. Assuming that the memories are mounted in the surface layers (first and sixth layers L1 and L6) of the module, FIGS. 17A and 17C show mounting pads 17p3-L1 and 17p3-L6 for the memories.

To simplify the wiring of the data bus in the vicinity of the memories, it is desirable that the same wiring patterns extending from the stub resistor side be arranged up to a portion below the memory mounting pads 17p3-L1 and above those 17p3-L6. In other words, since the data bus extending from the stub resistor mounting pads 16p2-L1 and 16p2-L6 to the memories 1410 is realized by the Wiring patterns 16s1-L3 and 16s1-L4 in the inner layers (third and fourth layers L3 and L4) in FIGS. 16A to 16C, it is preferable that the inner-layer wiring patterns 16s1-L3 and 16s1-L4 extend up to a portion below the memory mounting pads 17p3-L1 and above those 17p3-LB. However, the through-hole type vias cannot be formed on the memory mounting pads 17p3-L1 and 17p3-L6 for the above-mentioned reason, Therefore, wiring patterns 17s0-L1 and 17s0-L6 in the surface layers (first and sixth layers L1 and L0) serving as terminal supply lines, are connected to the mounting pads 17p3-L1 and 17p3-L6, respectively.

Further, vias cannot be formed on some of the pads 17p3 connected to the power-supply/GND layers. Therefore, the wiring patterns 17s0-L1 and 17s0-L6 in the surface layers L1 and L6 are connected as terminal supply lines to those pads.

Moreover, it is necessary to arrange the wiring patterns 17s0 in the surface layers (first and sixth layers L1 and L6) such that the respective lines avoid the memory mounting pads 17p3-L1 and 17p3-L6, power-supply/GND vias 17t0, and signal vias 17t1. Disadvantageously, the wiring layout has no flexibility in a memory pad region 17b1 as shown in FIG. 17A.

FIGS. 18A and 18B show an example of a memory system (below, referred to as a second related art) realized by applying the SLT interface to a connection pattern using mezzanine connectors.

Referring to FIGS. 18A and 18B, a male type mezzanine connector 1850 is provided on a motherboard 1800 having a memory controller 1801. A female mezzanine connector 1851 is provided on the lower surface of a memory module 1820 and a male connector 1852 is arranged on the upper surface thereof such that the connector 1852 corresponds to the connector 1851, with a module board therebetween. Similarly, a female mezzanine connector 1853 is provided on the lower surfaces of a memory module 1821 and a male mezzanine connector 1854 is provided on the upper surface thereof such that the connector 1854 corresponds to the connector 1853, with a module board therebetween. Further, a female mezzanine connector 1855 is provided on the lower surface of a termination memory module 1822, in which termination resistors 1865 are arranged. The memory modules 1820 to 1822 are attached to the motherboard 1800 such that the modules are stacked on the motherboard using the respective mezzanine connectors. An arrangement in which the memory controller 1801 is connected to the memories 1810 via a command and address bus 1830 and a data bus 1840 and a stub resistor 1880 is arranged in the command and address bus 1830 in each memory module is the same as that of the memory system in FIG. 10.

FIGS. 19A to 19C show the wiring layout of the data bus in a region 1820a in the vicinity of the connectors in the module 1820 in FIG. 18B. FIG. 19A is a top view of the wiring layout of the data bus in the region, FIG. 19B is a side view thereof, and FIG. 19C is a perspective view thereof.

Similar to the first related art, each module includes a module board having the same layer configuration as that in FIG. 15. It is assumed that the data bus is arranged using the inner layers (third and fourth layers L3 and L4). Adjusting means for the characteristic impedance of each line, the dielectric layers L0, and the power-supply/GND layers (second and fifth layers L2 and L5) are not shown in FIGS. 19A to 19C.

As understood from FIGS. 18B and 19A to 19C, it is necessary to connect the data bus 1840 to both of mezzanine connector mounting pads 19p1-L1 and those 19p1-L6 in the module 1820. The reason is that it is necessary to transmit signals, supplied to the mounting pads 19p1-L6 in the sixth layer L6 of the module 1820 from the motherboard 1800 through the mezzanine connectors 1850 and 1851, to the mounting pads 19p1-L1 in the first layer L1, and further transmit the signals to the next module 1821 through the mezzanine connectors 1852 and 1853.

In the present related art, the connection between the mounting pads 19p1-L1 and those 19p1-L6 through vias in the same way as the first related art is not possible, because it is necessary to arrange the data bus such that data bus lines extending from the mezzanine connector 1851 are connected to the memories 1810 and are then connected to the other mezzanine connector 1852. Specifically, as shown in FIGS. 19B and 19C, the data bus is arranged such that the data bus lines are connected to the fourth layer L4 through a wiring pattern 19s0-L6 extending from the pads 19p1-L6 in the surface layer (sixth layer L6) and vias 19t1, the data bus lines serving as an inner-layer wiring pattern 19s1-L4 extend to the memories, and after that, the data bus lines serving as an inner-layer wiring pattern 19s1-L3 extend backward to a portion in the vicinity of the mezzanine connector mounting pads and then connect to the pads 19p1-L1 in the surface layer (first layer L1) through the vias 19t1 and a wiring pattern 19s0-L1 in the surface layer L1. As mentioned above, according to the present related art, it is necessary to form the vias corresponding to the pads for the mezzanine connector 1851 and the pads for the mezzanine connector 1852. The number of vias in regions 19a10 and 19a11 is twice as much as that in the regions 16a10 and 16a11. To form vias for the pads mounting the mezzanine connectors 1851 and 1852, therefore, the present related art requires wider regions than those in the first related art.

FIGS. 20A and 20B show an example of a memory system (below, referred to as a third related art) realized by applying the P2P interface to a connection pattern using mezzanine connectors.

Referring to FIGS. 20A and 20B, a male mezzanine connector 2050 is provided on a motherboard 2000 having a memory controller 2001, A female mezzanine connector 2051 is provided on the lower surfaces of a memory module 2020 and a male mezzanine connector 2052 is provided on the upper surface thereof such that the connector 2052 corresponds to the connector 2051, with a module board therebetween. Further, a female mezzanine connector 2053 is provided on the lower surface of a memory module 2021. The memory modules 2020 and 2021 are attached to the motherboard 2000 such that the modules are stacked on the motherboard using the respective mezzanine connectors. An arrangement in which the memory controller 2001 is connected to memories 2010 through command and address buses 2030 and 2031 and data buses 2040 and 2041 is the same as that of the memory system in FIG. 11. As understood from FIG. 20B, in this system, each of the data buses 2040 and 2041 each corresponding to one channel is connected to two memories 2010. In a strict sense, one-to-two connection is provided. Generally, two memories can be regarded as a load of one lumped constant circuit. Accordingly, this connection pattern can be handled as one-to-one (point-to-point) connection.

FIGS. 21A to 21C show the wiring layout of the data buses in a region 2020a in the vicinity of the connectors in the module 2020 in FIG. 20B. FIG. 21A is a top view of the wiring layout of the data buses in the region 2020a, FIG. 21B is a side view thereof, and FIG. 21C is a perspective view thereof.

Similar to the first and second related arts, each module includes a multilayer circuit board having the same layer configuration as that in FIG. 15. It is assumed that the data buses are arranged mainly using the inner layers (third and fourth layers L3 and L4).

According to the present related art, as understood from FIG. 20B, it is unnecessary to connect all of mounting pads for the mezzanine connector 2051 of the module 2020 to the corresponding mounting pads for the mezzanine connector 2052, respectively. In other words, among the pads mounting the mezzanine connector 2051, the pads connected to the data bus 2040 are not connected to the pads mounting the mezzanine connector 2052. The other pads connected to the other data bus 2041 may be connected to the corresponding pads mounting the mezzanine connector 2052. According to the present related art, the data bus 2040 is arranged such that data bus lines extend from mounting pads 21p1-L6 for the mezzanine connector 2051 to an inner-layer wiring pattern 21s1-L4 through a wiring pattern 21s0-L6 in the surface layer (sixth layer L6) and some vias 21t1 as shown by the left bidirectional arrow in FIGS. 21B and 21C. The data bus 2041 is arranged such that data bus lines extend from the other mounting pads 21p1-L6 in the surface layer L6 to mounting pads 21p1-L1 through the wiring pattern 21s0-L6 in the surface layer (sixth layer L6), the other vias 21t1, and a wiring pattern 21s0-L1 in the surface layer (first layer L1) as shown by the right bidirectional arrow in FIGS. 21B and 21C.

Referring to FIG. 21A, according to the present related art, similar to the first and second related arts, the vias cannot be formed on and under the mezzanine connector mounting pads 21p1. Therefore, it is necessary to provide regions 21a10 and 21a11 for via formation. As understood from FIGS. 21B and 21C, since each via is a through-hole type, the via has a redundant portion 21a30 which is not required for signal transmission.

FIGS. 22A and 22B show an example of a memory system (below, referred to as a fourth related art) realized by applying the P2P interface to a connection pattern using mezzanine connectors. In the system, each module has a buffer.

Referring to FIGS. 22A and 22B, a male mezzanine connector 2250 is provided on a motherboard 2200 having a memory controller 2201. A female mezzanine connector 2251 is provided on the lower surface of a memory module 2220 and a male mezzanine connector 2252 is provided in the corresponding position on the upper surface thereof. Further, a female mezzanine connector 2253 is provided on the lower surface of a memory module 2221. The memory modules 2220 and 2221 are attached to the motherboard 2200 such that the modules are stacked on the motherboard using the respective mezzanine connectors.

In the memory system, the memory controller 2201 is connected to a buffer in the module 2220 in a one-to-one relationship by a bus assembly 2270 having no stubs and including a plurality of address and command buses and a plurality of data buses. Similarly, the buffer in the module 2220 is connected to a buffer 2203 in the module 2221 in a one-to-one relationship by the bus assembly 2270.

As understood from the comparison between a region 2220a in the vicinity of the connectors in FIG. 22B and the region 1820a in FIG. 18B, the present related art requires a region where vias are formed in a manner similar to the second related art. Each via has a redundant portion which is not required for signal transmission.

According to the above-mentioned bus connection structures using mezzanine connectors, the mounted area on a motherboard can be widely reduced as compared with the case using card edge connectors, However, in realizing higher data transfer rate of a memory system while the system structure and its data bus connection pattern are not changed, the inventors of the present invention have found the following disadvantages.

Regarding the first related art, the regions 16a10, 16a11, 16a20, 16a21, and 16a22 are provided in FIG. 16A. Accordingly, the length of wiring is long. Disadvantageously, this leads to signal delay and degradation in signal quality, thus restricting data transfer rate. The redundant portions 16a30 and 16a31 in FIG. 16B also cause the degradation in signal quality, so that the data transfer rate is limited, Specifically, as mentioned above, the wiring of each module is designed such that the characteristic impedance of each line is, for example, 60 ohms. The design for impedance is accomplished by opposing signal lines to the reference plane of each power-supply/GND layer including signal return paths. However, vias for signal cannot be arranged close to vias for the reference plane because of design difficulty. Unfortunately, impedance mismatching occurs between the signal vias and the wiring pattern. In this case, it seems that each via has inductance (L), capacitance (C), and resistance (R), which are small, in a manner similar to a lumped constant circuit. However, when signal transfer rate is low (frequency is low), the impedance mismatching between the vias and the wiring pattern hardly affect signal quality. When signal frequency is several hundreds of MHz or higher, the magnitudes of L, C, and R affect the signal quality. Each of the redundant portions 16a30 and 16a31 has unnecessary capacitance with respect to a signal (high frequency signal) transferred at high rate, thus generating large parasitic capacitance (C). This causes multiple signal reflection, resulting in degradation in signal quality.

According to the first related art, disadvantageously, the terminal supply lines to the respective pads are realized by the wiring patterns 16s0-L1, 16s0-L6, 17s0-L1, 17s0-L6 in the surface layers (first and sixth layers L1 and L6). Specifically, it is necessary to arrange each surface-layer wiring pattern so that the pattern avoids both of the pads and the vias. Therefore, delay and degradation in signal quality caused by the long wiring is not negligible. Additionally, the difference in signal propagation velocity between the surface layer wiring and the Inner layer wiring and the difference in susceptibility to noise (crosstalk) therebetween are also disadvantages. Desirably, a wiring pattern in each power-supply/GND layer is arranged up to the memory mounting pads with low impedance. Disadvantageously, the impedance increases by the wiring patterns 17s0-L1 and 17s0-L6 in the surface layers (first and sixth layers L1 and L0).

The present inventors also have found that the second to fourth related arts have the same disadvantages as those of the first related art.

In stacking a plurality of memory modules with mezzanine connectors, as the number of memory modules increases, the difference in length of wiring from the memory controller between the memory modules also increases, thus restricting data transfer rate.

As mentioned above, Patent Document 3 discloses the use of the interstitial via holes instead of through holes. However, Patent Document 3 has no suggestion regarding the application of interstitial via holes to a memory system, particularly, an increase in data transfer rate of the memory system. Further, Patent Document 3 makes no disclosure and no suggestion for a cause of disturbing the increase in data transfer rate when the technique using mezzanine connectors is introduced to the memory system.

### SUMMARY OF THE INVENTION

Accordingly, it is an object of the present invention to provide a memory system which can realize higher bus data transfer rate than that of a conventional one and in which the mounted area on a motherboard is small,

Another object of the present invention is to provide a memory system in which the impedance of each line in each power-supply/ground layer in each module can be lowered than that of a conventional one, thus realizing higher data transfer rate of the memory system.

To accomplish the first object of the present invention, the memory system includes: a plurality of memory modules each of which a plurality of memories are mounted in; a memory controller for controlling the memories; a motherboard in which the memory controller is mounted; and mezzanine connectors serving as means for electrically connecting the motherboard to the memory modules, wherein each memory module includes blind vias and buried vias.

Preferably, the blind vias and the buries vias include stacked blind vias and buried vias for connecting only specific layers so that the vias have no redundant portions in signal transmission routes, and at least some of a plurality of pads formed on the upper surface and/or the lower surface of each memory module are formed on the blind vias, or above or below the buried vias.

Preferably, the memory system according to the present invention has a data bus structure according to the SSTL interface in which the memory controller is connected to the memories via a plurality of resistance elements each serving as a stub resistor and a plurality of lines with stubs.

Preferably, the memory system according to the present invention has a data bus structure according to the SLT interface in which the memory controller is connected to the memories via a plurality of single-stroke lines with no stubs and the far end of each line is terminated by a termination resistor.

Further, the memory system according to the present invention may have a data bus structure according to the P2P interface in which the memory controller is connected to each of the memories in a one-to-one relationship via a plurality of lines with no stubs.

Moreover, the memory system according to the present invention may have another data bus structure according to the P2P interface in which a buffer is arranged in each of the memory modules and the memory controller is connected to the buffers via a plurality of single-stroke lines with no stubs.

To accomplish the second object of the present invention, in the memory system, preferably, the vias are formed on mounting pads for power supply or ground.

According to the present invention, advantageously, since the blind vias and buried vias are used, disadvantages of a conventional module using mezzanine connectors can be overcome. In other words, via forming regions and redundant portions, which are not required for signal transmission routes, can be eliminated. Thus, the area of the module can be reduced and the length of wiring can be shortened. This leads to a realization of higher data transfer rate of a data bus and a reduction in mounted area on a motherboard.

Further, according to the present invention, since the vias can be directly connected to the pads for mounting devices, the impedance of each line in each power supply or ground layer can be lowered than that of a conventional system. Thus, data transfer rate of the present memory system can be further increased.

### BRIEF DESCRIPTION OF THE DRAWINGS

FIG. 1A is a top view of the wiring layout of a data bus in a region in the vicinity of mezzanine connectors in a memory module according to a first embodiment of the present invention:

FIG. 1B is a side view of the wiring layout of the data bus in FIG. 1A;

FIG. 1C is a perspective view thereof;

FIG. 2A is a top view of the wiring layout of the data bus in a region in the vicinity of memories in the memory module according to the first embodiment of the present invention;

FIG. 2B is a side view of the wiring layout of the data bus in FIG. 2A;

FIG. 2C is a perspective view thereof;

FIG. 3A is a top view of the wiring layout of a data bus in a region in the vicinity of mezzanine connectors in a memory module according to a second embodiment of the present invention;

FIG. 3B is a side view of the wiring layout of the data bus in FIG. 3A;

FIG. 3C is a perspective view thereof;

FIG. 4A is a top view of the wiring layout of a data bus in a region in the vicinity of mezzanine connectors in a memory module according to a third embodiment of the present invention;

FIG. 4B is a side view of the wiring layout of the data bus in FIG. 4A;

FIG. 4C is a perspective view thereof:

FIGS. 5A and 5B are diagrams explaining a mechanism for preventing the memory module according to any one of the first to third embodiments of the present invention from dropping off, FIG. 5A being a perspective view of a memory system, FIG. 5B being a plan view of each memory module having a tapped hole and explaining the position of the tapped hole;

FIG. 6A is a perspective view of a memory system with memory modules according to a fourth embodiment of the present invention;

FIG. 6B is a diagram of the connection pattern of a data bus of the memory system in FIG. 6A;

FIGS. 7A and 7B are perspective views of a memory system with a memory module according to a fifth embodiment of the present invention;

FIG. 8A is a top view of the wiring layout of a data bus in a region in the vicinity of mezzanine connectors in the memory module according to the fifth embodiment of the present invention;

FIG. 8B is a side view of the wiring layout of the data bus in FIG. 8A;

FIG. 8C is a perspective view thereof;

FIG. 9 is a schematic diagram of the structure of a first conventional memory system;

FIG. 10 is a schematic diagram of the structure of a second conventional memory system;

FIG. 11 is a schematic diagram of the structure of a third conventional memory system;

FIG. 12 is a schematic diagram of the structure of a fourth conventional memory system;

FIG. 13 is a diagram explaining how to stack memory modules using conventional mezzanine connectors:

FIGS. 14A and 14B show an example of a memory system according to a first related art, FIG. 14A showing the structure of the system, FIG. 14B showing a data bus connection pattern thereof;

FIG. 15 is a diagram showing an example of the layer configuration of a multilayer circuit board used as a memory module;

FIG. 16A is a top view of the wiring layout of a data bus in a region in the vicinity of mezzanine connectors in a memory module according to the memory system in FIGS. 14A and 14B;

FIG. 16B is a side view of the wiring layout of the data bus in FIG. 16A:

FIG. 16C is a perspective view thereof:

FIG. 17A is a top view of the wiring layout of the data bus in a region in the vicinity of memories in the memory module in the memory system in FIGS. 14A and 14B;

FIG. 17B is a side view of the wiring layout of the data bus in FIG. 17A;

FIG. 17C is a perspective view thereof;

FIGS. 18A and 18B show an example of a memory system according to a second related art, FIG. 18A showing the structure of the system, FIG. 18B showing a data bus connection pattern thereof;

FIG. 19A is a top view of the wiring layout of a data bus in a region in the vicinity of mezzanine connectors in the memory module in the memory system in FIGS. 18A and 18B:

FIG. 19B is a side view of the wiring layout of the data bus in FIG. 19A;

FIG. 19C is a perspective view thereof;

FIGS. 20A and 20B show an example of a memory system according to a third related art, FIG. 20A showing the structure of the system, FIG. 20B showing a data bus connection pattern;

FIG. 21A is a top view of the wiring layout of a data bus in a region in the vicinity of mezzanine connectors in the memory module in the memory system in FIGS. 20A and 20B;

FIG. 21B is a side view of the wiring layout of the data bus in FIG. 21A;

FIG. 21C is a perspective view thereof; and

FIGS. 22A and 22B show an example of a memory system according to a fourth related art, FIG. 22A showing the structure of the system, FIG. 22B showing a data bus connection pattern thereof.

### DESCRIPTION OF THE PREFERRED EMBODIMENTS

Embodiments of the present invention will now be described in detail with reference to the drawings.

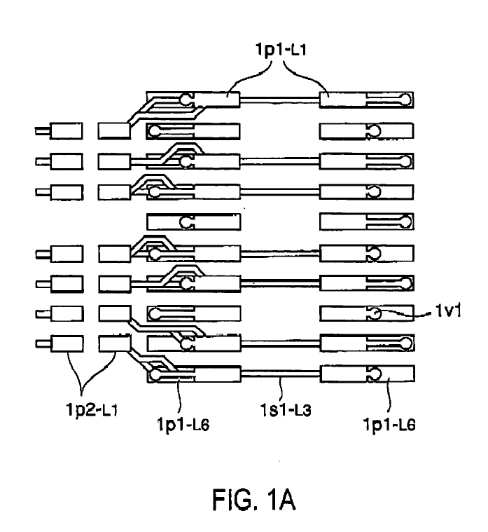

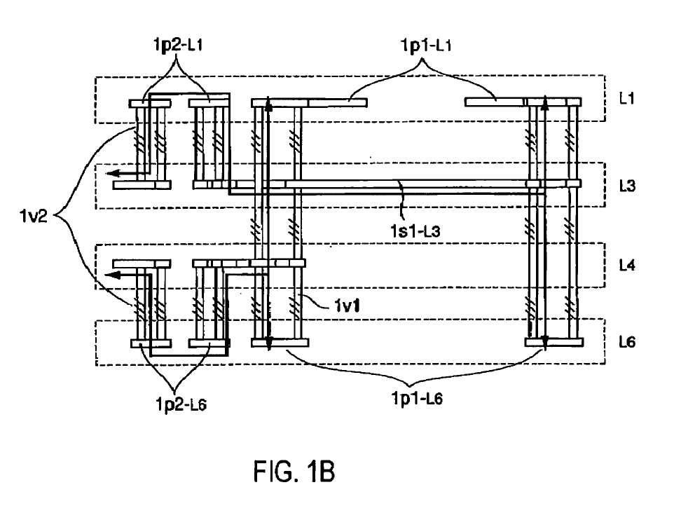

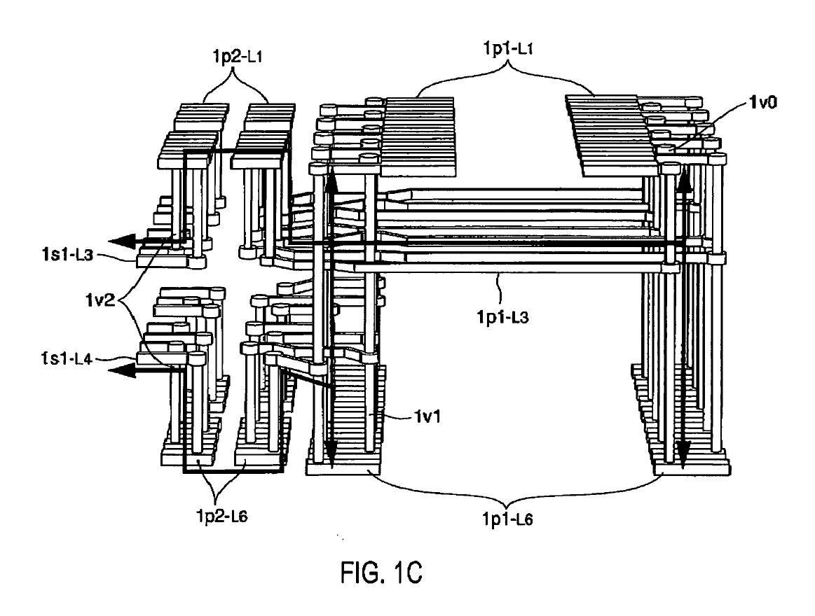

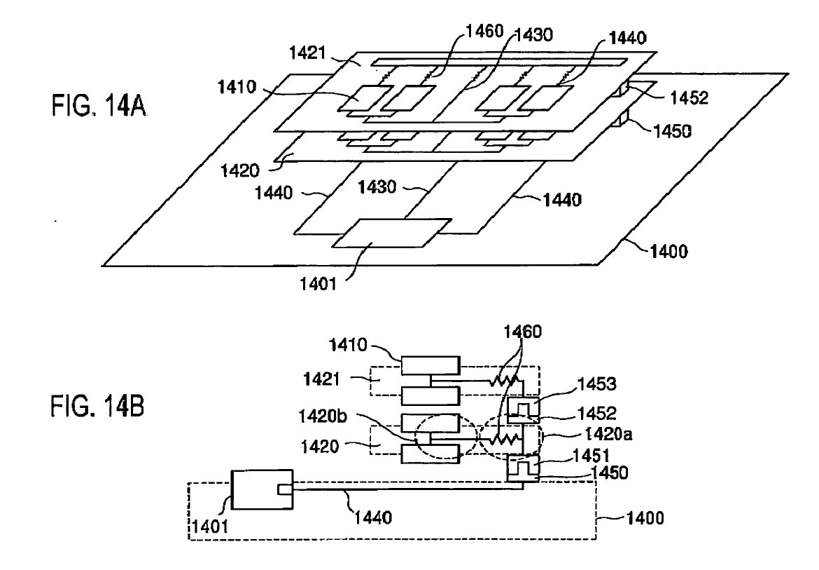

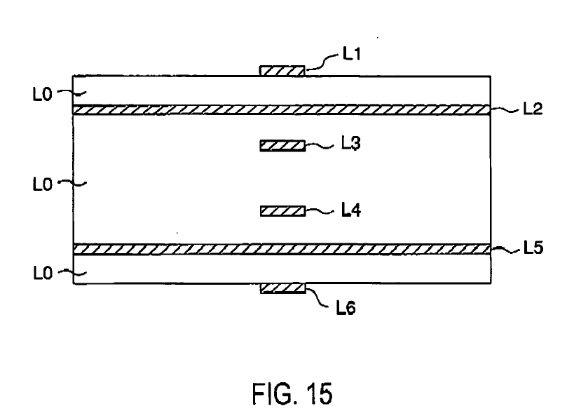

FIGS. 1A to 1C are diagrams explaining the wiring layout of a memory module according to a first embodiment of the present invention. The memory module according to the present embodiment is used to realize a memory system having the data bus connection pattern shown in FIGS. 14A and 14B. In other words, the present memory module is electrically connected to a motherboard or another memory module with at least one mezzanine connector. The memory module has a data bus according to the SSTL interface, namely, the data bus including a plurality of stub resistors and a plurality of lines with stubs. The data bus electrically connects a memory controller on the motherboard to memories. The memory module includes a memory module board having the same layer configuration as that in FIG. 15.

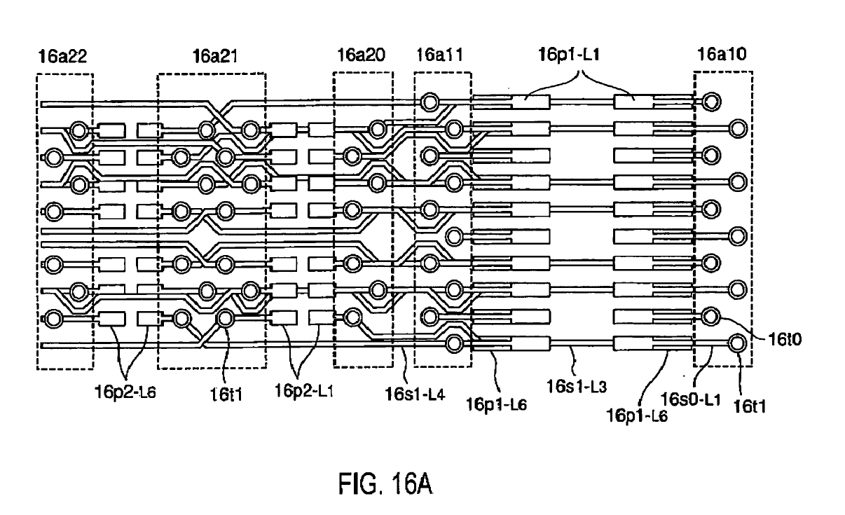

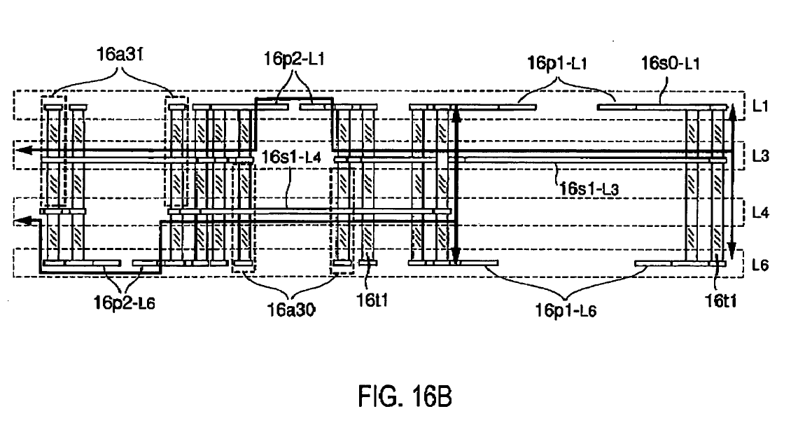

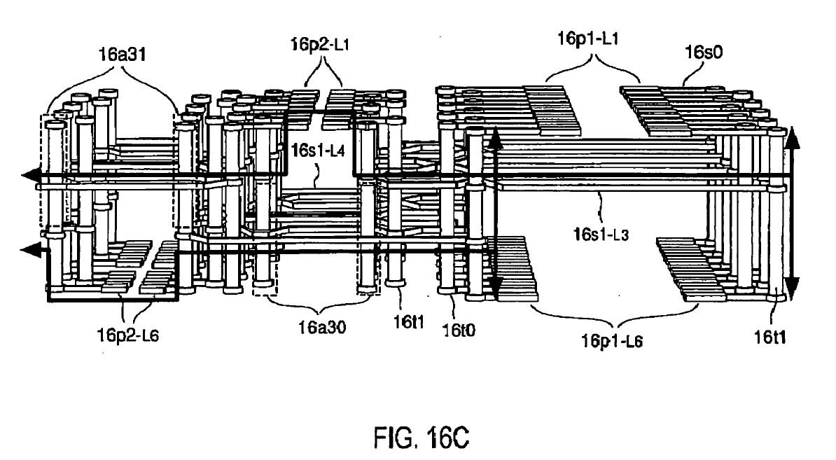

FIGS. 1A to 1C correspond to FIGS. 16A to 16C, respectively. FIG. 1A is a top view of the wiring layout of the data bus in a region corresponding to the region 1420a in the vicinity of the connectors in FIG. 14B. FIG. 1B is a side view thereof and FIG. 1C is a perspective view thereof. Similar to FIGS. 16B and 16C, the arrows in FIGS. 1B and 1C denote signal transmission routes, respectively.

As understood from FIGS. 1A to 1C, each mezzanine connector mounting pad 1p1-L6 on the lower surface of the memory module has a pad-on-via structure and is formed on (under in FIGS. 1B and 1C) a stacked via 1v1 for signal. Similarly, each of stub resistor mounting pads 1p2-L1 and 1p2-L6 has a pad-on-via structure and is formed on a stacked via 1v2 for signal.

The signal stacked vias 1v1 connected to the respective mezzanine connector mounting pads 1p1-L6 on the lower surface include blind vias and buried vias for connecting the layers L1 to L6. The vias 1v2 connected to the stub resistor mounting pads 1p2-L1 include stacked blind vias for connecting the first layer L1 to the third layer L3 of the module board. The vias 1v2 connected to the stub resistor mounting pads 1p2-L6 include stacked blind vias for connecting the sixth layer L6 to the fourth layer L4 of the module board.

In this instance, a blind via connects the surface layer (L1 or L6) to any of the inner layers in the board. A buried via is not connected to the surface layer and connects any two layers (namely, inner layers) to each other in the board. A stacked via includes at least one blind via and at least one buried via, each of which connects two adjacent layers. The blind vias and the buried vias are stacked (coupled to each other) in forming a multilayer circuit board to form the stacked via, thus connecting separate layers, for example, the surface layers (first and sixth layers L1 and L6),

With the above-mentioned structure, the memory module according to the present embodiment has the following advantages.

As understood from the comparison between FIGS. 1A and 16A, the memory module according to the present embodiment has no regions 16a10, 16a11, 16a20, 16a21, and 16a22 where the through-hole vias are formed in FIG. 16A. Via forming regions can be included in mounting pad regions by using the pad-on-via structure. Thus, the regions exclusively used for via formation can be eliminated. This leads to a reduction in size of the memory module and a reduction in distance between the mezzanine connector mounting pad pattern and the stub-resistor mounting pad pattern, namely, the length of wiring therebetween, thus overcoming a disadvantage in that the length of bus wiring in a mounting pattern using mezzanine connectors is longer than that using card edge connectors.

As understood from FIG. 1B, in the memory module according to the present embodiment, the regions for the stub resistor mounting pads can be arranged so as to correspond to each other on the upper and lower surfaces. The size of the memory module and the length of wiring can be further reduced. This is accomplished by using the stacked blind vias 1v2 respectively connected to the mounting pads 1p2-L1 and 1p2-L2.

Moreover, as clear from the comparison between FIGS. 1B and 16B and/or that between FIGS. 1C and 16C, the memory module according to the present embodiment has no redundant portions (16a30 and 16a31 in FIGS. 16B and 16C) which are not required for signal transmission. This is also accomplished by using the stacked blind vias 1v2 respectively connected to the mounting pads 1p2-L1 and 1p2-L2.

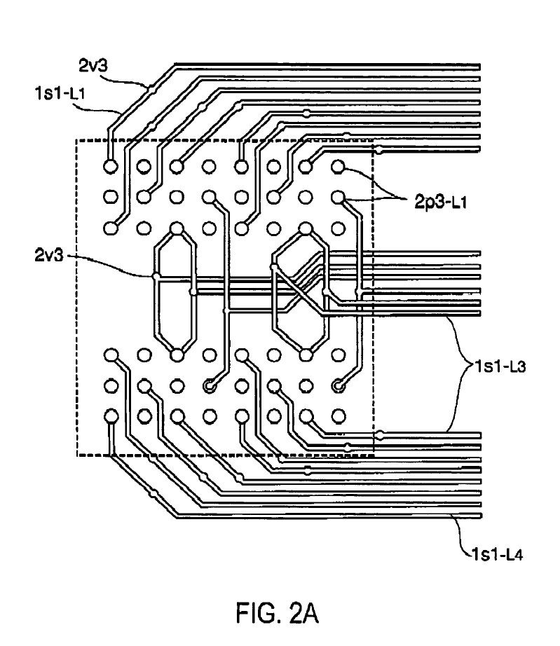

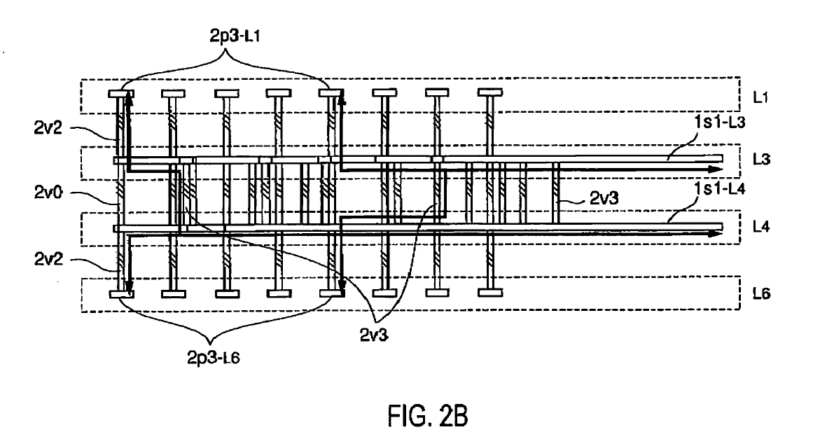

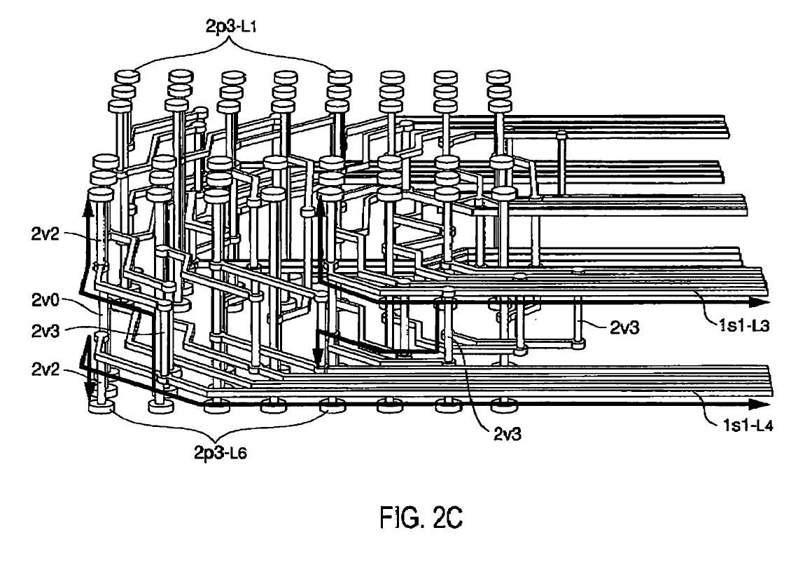

The wiring layout of the data bus in a region in the vicinity of memories in the memory module according to the first embodiment will now be described below with reference to FIGS. 2A to 2C.

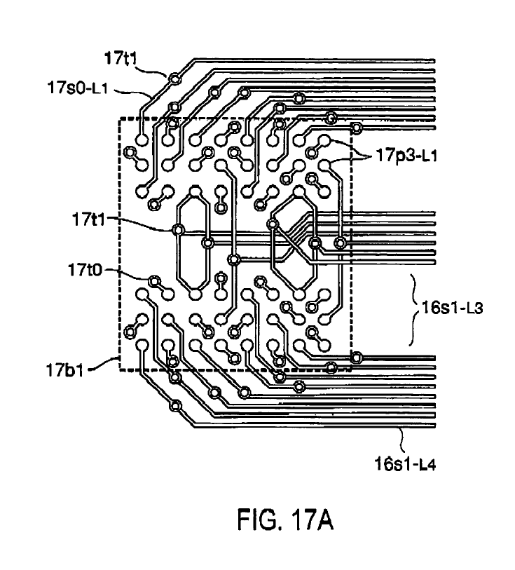

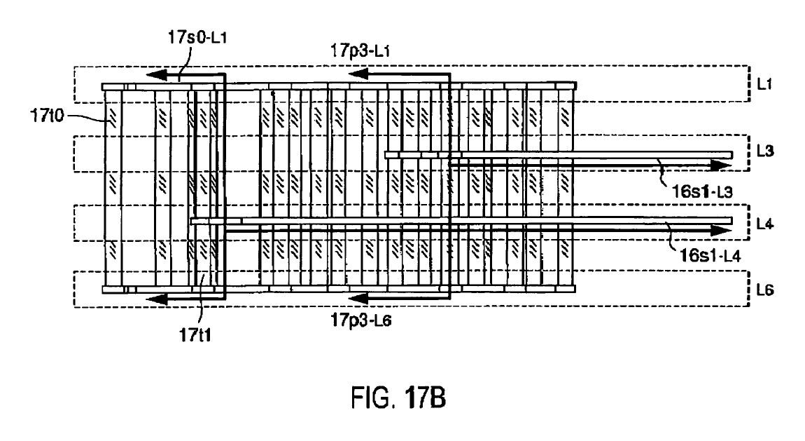

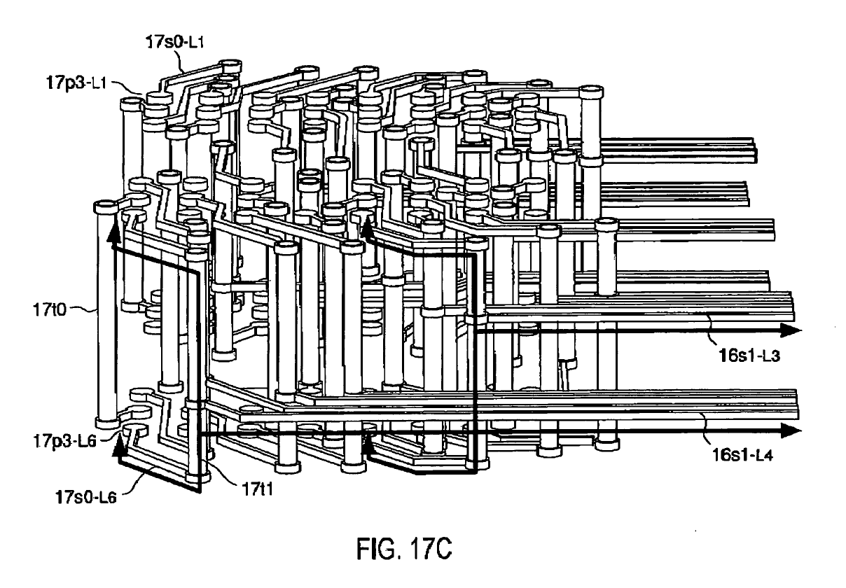

FIGS. 2A to 2C correspond to FIGS. 17A to 17C, respectively. FIG. 2A is a top view of the wiring layout of the data bus in a region corresponding to the region 1420b in the vicinity of the memories in FIG. 14B. FIG. 28 is a side view thereof and FIG. 2C is a perspective view thereof.

Referring to FIGS. 2A to 2C, all of pads 2p3-L1 and 2p3-L6 for mounting the memories of the memory module according to the present embodiment have the pad-on-via structure. Among the memory mounting pads 2p3-L1, the pads for signal are connected to the wiring in the third layer L3 through stacked blind vias 2v2, Among the memory mounting pads 2p3-L6, the pads for signal are connected to the wiring in the fourth layer L4 through the stacked blind vias 2v2. The wiring in the third layer L3 is connected to that in the fourth layer L4 through stacked buried vias 2v3 for signal. The mounting pads 2p3-L1 and 2p3-L6 for power supply or ground (GND) are connected to each other through stacked vias (blind vias and buried vias) 2v0 such that the pads 2p3-L1 on the upper surface correspond to those 2p3-L6 on the lower surface, respectively.

The mounting pads 2p3-L1 and 2p3-L6 for power supply/GND are also connected to the power-supply/GND layers, i.e., the second and fifth layer (not shown), respectively.

As understood from the comparison between FIGS. 2B and 17B and that between FIGS. 2C and 17C, according to the present embodiment, the memory module has no wiring in the surface layers. The use of the stacked blind vias 2v2 and the stacked buried vias 2v3 realizes the arrangement of inner-layer wiring patterns 1s1-L3 and 1s1-L4 just below the memory mounting pads 2p3-L1 and just above the memory mounting pads 2p3-L6.

In the memory module according to the present embodiment, since the vias are formed under the power-supply/GND mounting pads 2p3-L1 and on the power-supply/GND mounting pads 2p3-L6, the impedance of each line in the power supply or ground layers can be reduced.

As mentioned above, in the memory module according to the present embodiment, the reduction in size thereof, the reduction in length of wiring, the elimination of redundant portions in the signal transmission routes, the elimination of wiring in the surface layers, and the reduction in impedance of each line in the power-supply/GND layers can be realized. A memory system capable of transferring data at higher rate can be formed using the module with the above-mentioned structure.

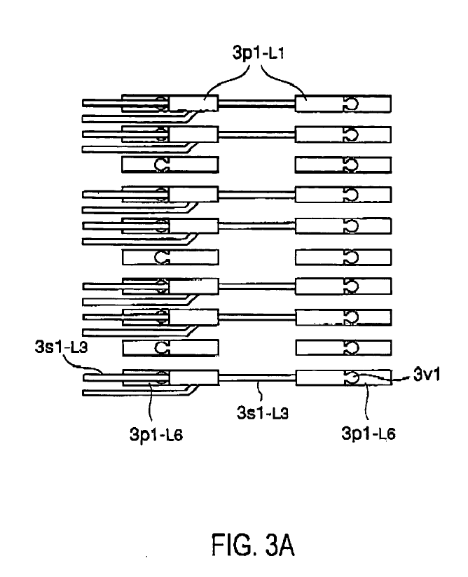

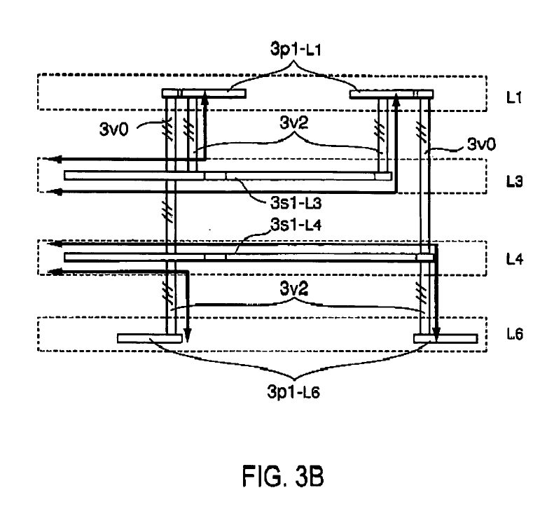

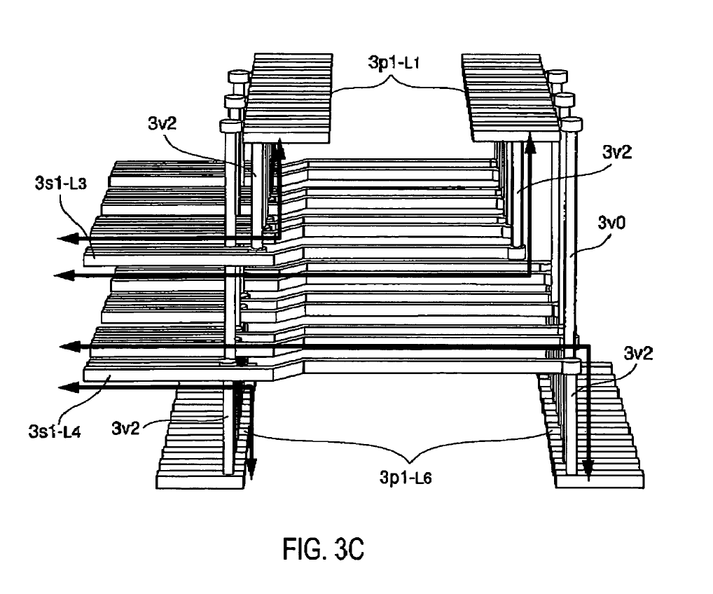

A memory module according to a second embodiment will now be described below with reference to FIGS. 3A to 3C.

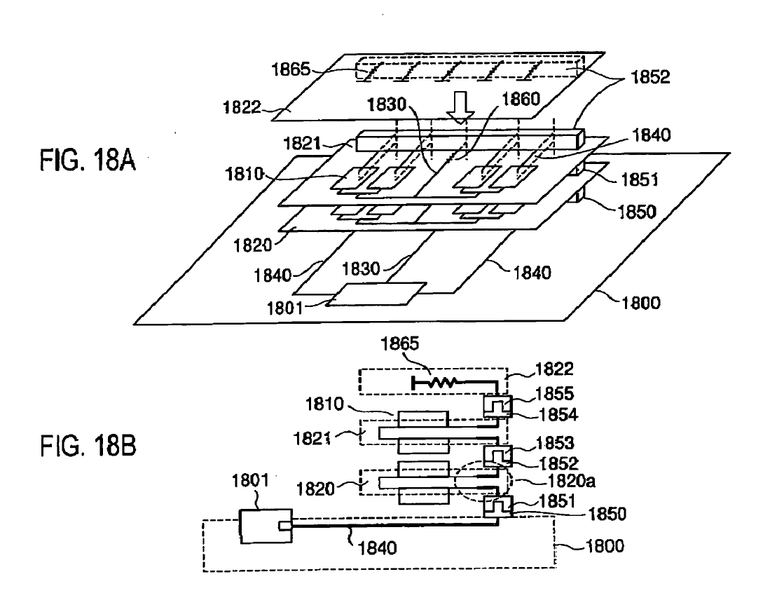

The memory module according to the present embodiment is used to realize a memory system having the data bus connection pattern shown in FIGS. 18A and 18B. In other words, the present memory module is electrically connected to a motherboard or another memory module with at least one mezzanine connector. The memory module has a data bus according to the SLT interface, namely, the data bus including a plurality of single-stroke lines with no stubs.

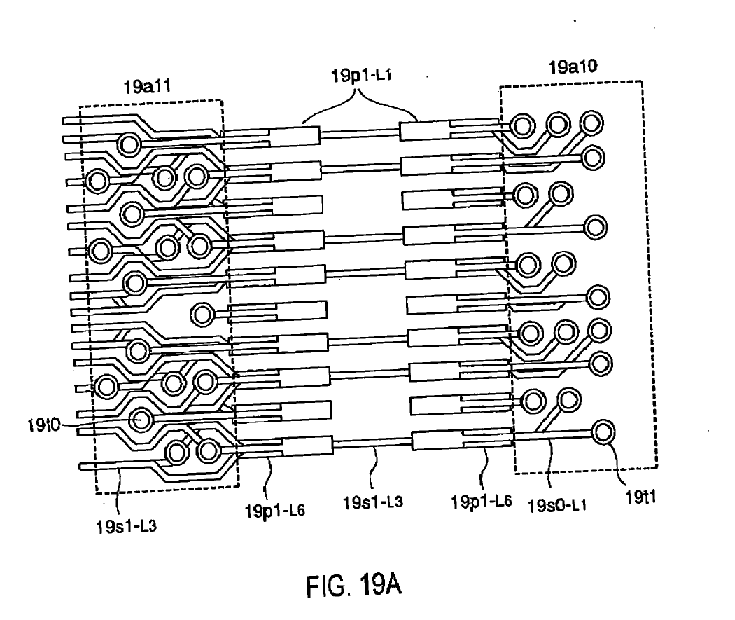

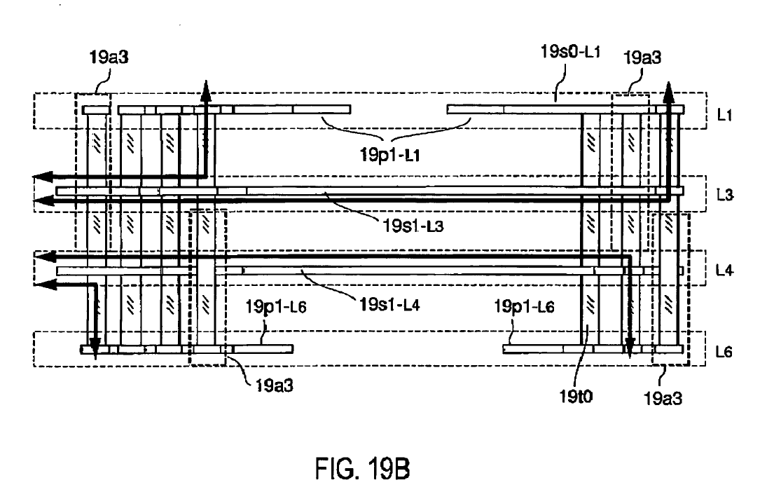

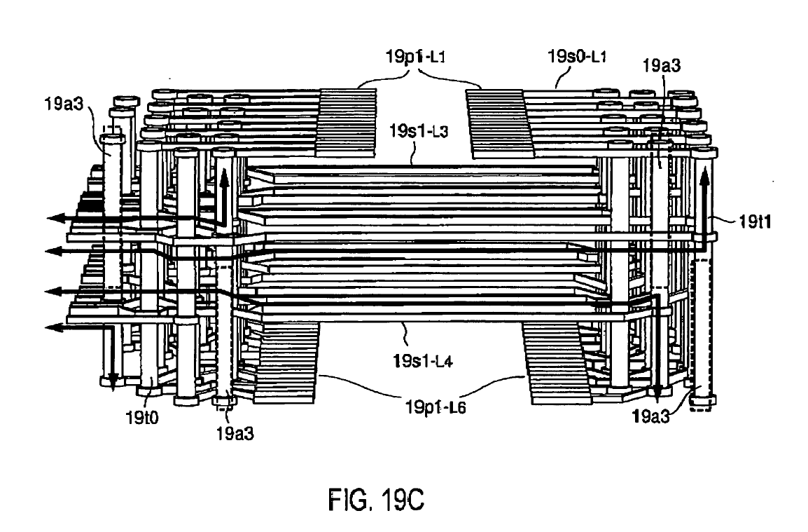

FIGS. 3A to 3C correspond to FIGS. 19A to 19C, respectively. FIG. 3A is a tope view of the wiring layout of the data bus in a region corresponding to the region 1820a in the vicinity of the connectors in FIG. 18B. FIG. 3B is a side view thereof and FIG. 3C is a perspective view thereof. The memory module includes a memory module board having the same layer configuration as that in FIG. 15.

Referring to FIGS. 3A to 3C, among mezzanine connector mounting pas of the memory module according to the present embodiment, each mounting pad 3p1-L6 on the lower surface has a pad-on-via structure. Some mounting pads for signal among mounting pads 3p1-L1 on the upper surface have the pad-on-via structure. The other mounting pads 3p1-L1 for power-supply/GND on the upper surface are arranged very close to vias to be connected thereto. The length of wiring between each pad and the corresponding via is very short.

Among the mounting pads 3p1-L1 on the upper surface, the mounting pads for signal are connected to a signal wiring pattern 3s1-L3 in the third layer L3 through stacked blind vias 3v2, The other mounting pads 3p1-L1 (for power-supply/GND) on the upper surface are connected to the corresponding pads 3p1-L6 on the lower surface through stacked vias (blind vias and buried vias) 3v0 and are also connected to the power-supply/GND layers (the second and fifth layers L2 and L5) through the vias 3v0. The mounting pads 3p1-L6 for signal on the lower surface are connected to a signal wiring pattern 3s1-L4 in the fourth layer L4 through the stacked blind vias 3v2.

As understood from the comparison between FIGS. 3A and 19A, the memory module according to the present embodiment does not have the via forming regions 19a10 and 19a11. Necessary vias can be formed in pad forming regions by using the stacked blind vias and buried vias.

As understood from the comparison between FIGS. 3B and 19B and that between FIGS. 3C and 19C, the memory module according to the present embodiment has no redundant portions which are not required for signal transmission. The signal wiring patterns include no parts in the surface layers. This is accomplished by connecting the mounting pads for signal and the signal wiring patterns with the stacked blind vias and buried vias.

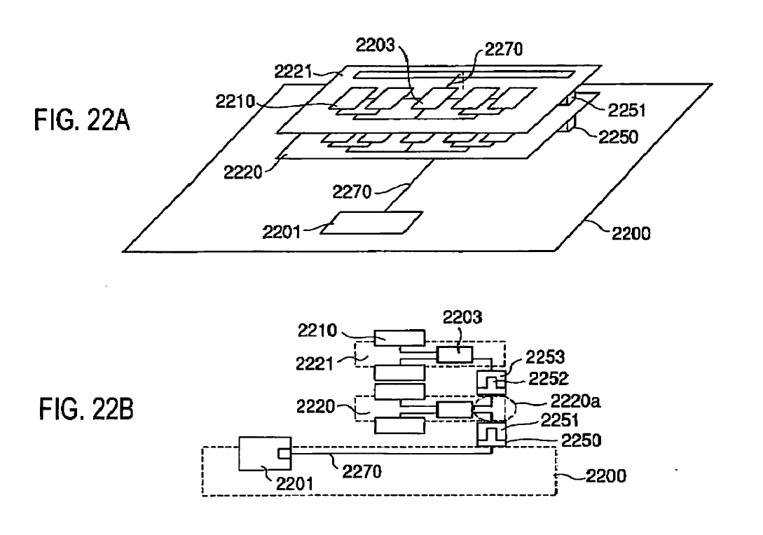

The wiring layout of the memory module according to the present embodiment can be applied to each memory module used in the memory system having the connection pattern in FIGS. 22A and 22B. In other words, the wiring layout according to the present embodiment can be applied to a memory module that is electrically connected to a motherboard or another memory module via at least one mezzanine connector and that has a data bus according to the P2P interface, namely, the data bus including a plurality of lines with no stubs. In this case, the memory controller and the buffer of the nearest memory module from the motherboard, and the buffers of the two adjacent memory modules are connected in a one-to-one relationship through the data bus, respectively.

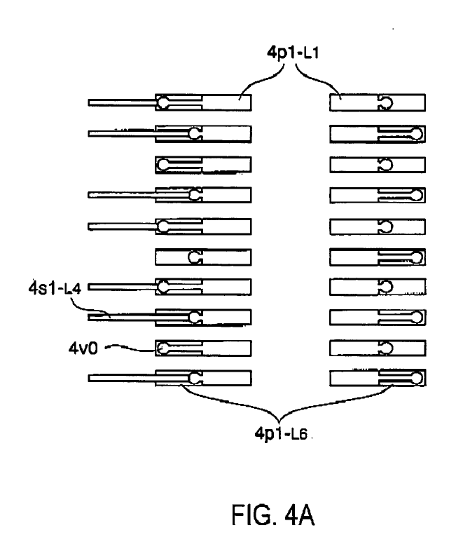

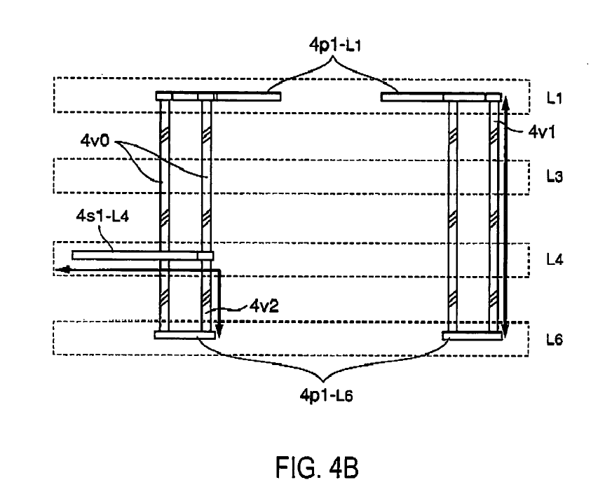

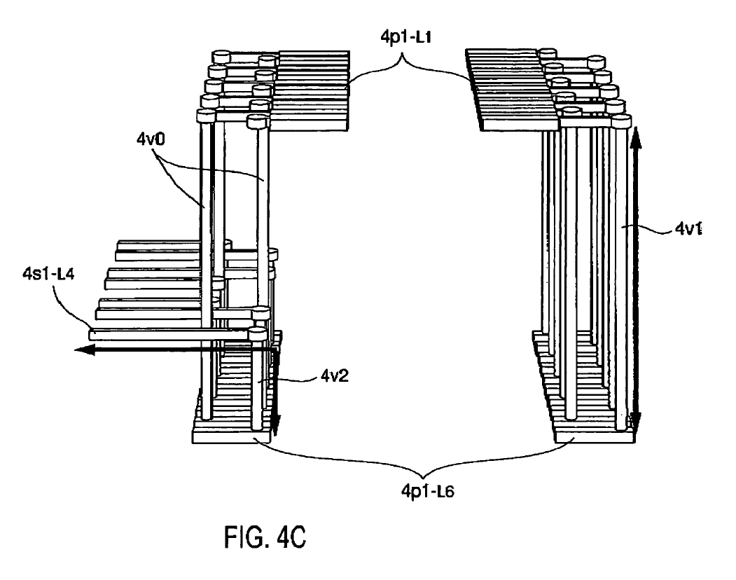

A memory module according to a third embodiment of the present invention will now be described below with reference to FIGS. 4A to 4C.

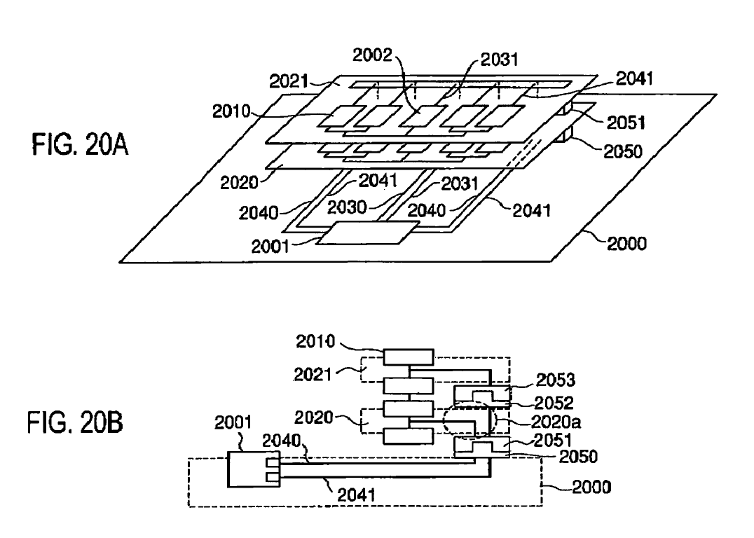

The memory module according to the present embodiment is used to realize a memory system having the data bus connection pattern in FIGS. 20A and 20B. The memory module is electrically connected to a motherboard or another memory module via at least one mezzanine connector. The memory module has a data bus according to the P2P interface, whereby a memory controller is connected to each memory in a one-to-one relationship through a plurality of lines with no stubs.

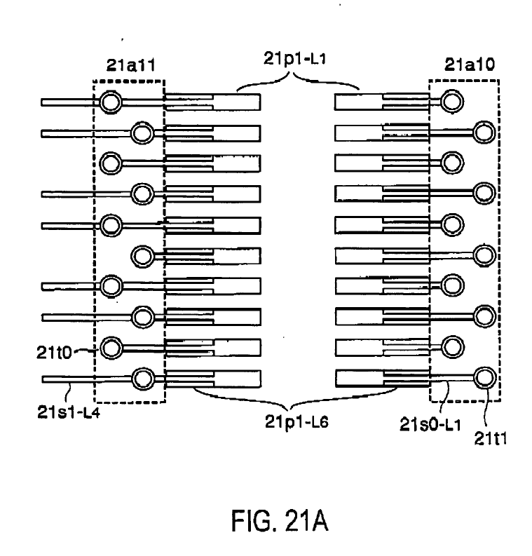

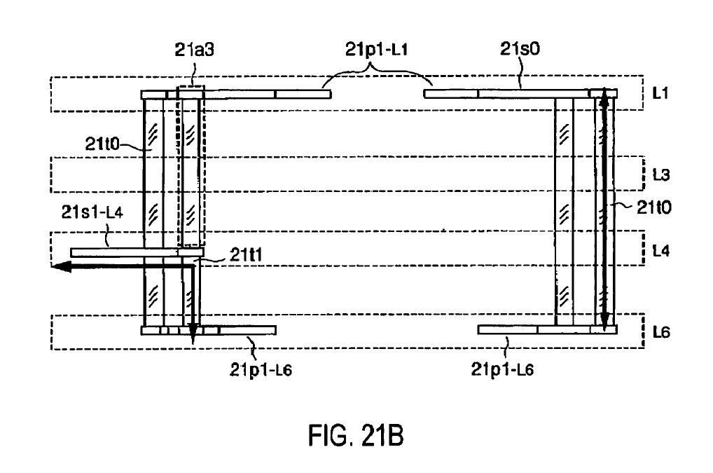

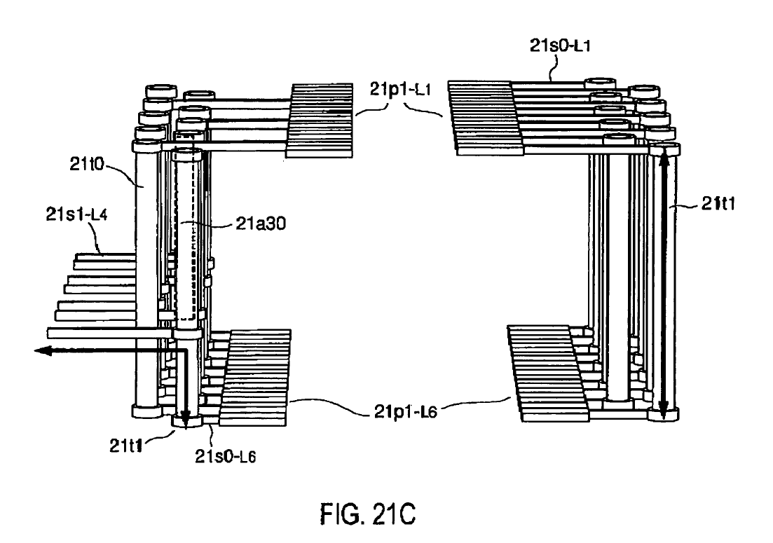

FIGS. 4A to 4C correspond to FIGS. 21A to 21C, respectively. FIG. 4A is a top view of the wiring layout of the data bus in a region corresponding to the region 2020a in the vicinity of the connectors in FIG. 20B. FIG. 4B is a side view thereof and FIG. 4C is a perspective view thereof. The memory module includes a memory module board having the same layer configuration as that in FIG. 15.

Referring to FIGS. 4A to 4C, among mezzanine connector mounting pads of the memory module according to the present embodiment, each mounting pad 4p1-L6 on the lower surface has a pad-on-via structure. Some of the mounting pads 4p1-L0 on the lower surface are connected to a surface-layer wiring pattern through stacked vias (blind vias and buried vias) 4v0 for power-supply/GND and stacked vias (blind vias and buried vias) 4v1 for signal. The other mounting pads 4p1-L6 are connected to a signal wiring pattern 4s1-L4 through blind vias 4v2 for signal. Some mounting pads 4p1-L1 on the upper surface are connected to the stacked vias (blind vias and buried vias) 4v0 for power-supply/GND through a short wiring pattern and the other mounting pads 4p1-L1 are connected to the stacked vias 4v1 for signal through a short wiring pattern.

As understood from the comparison between FIGS. 4A and 21A, the memory module according to the present embodiment has no via forming regions, Further, the length of wiring in the surface layer is significantly shortened. Moreover, as understood from the comparison between FIGS. 4B and 21B and that between FIGS. 4C and 21C, the memory module according to the present embodiment has no redundant portions which are not required for signal transmission. This is accomplished by the structure in which the stacked blind vias and buried vias are used and some of the mounting pads have the pad-on-via structure.

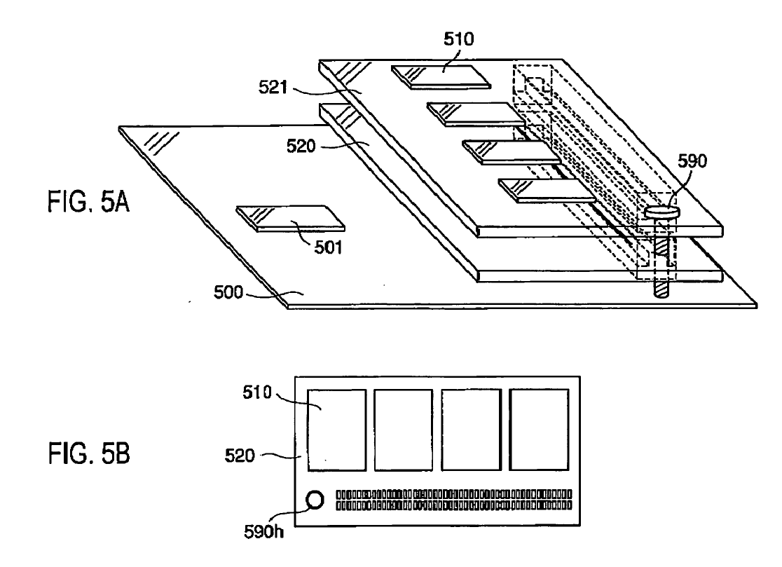

According to the first to third embodiments mentioned above, a plurality of memory modules are provided on the motherboard in a cantilever manner. To prevent the memory modules from dropping off, the stacked modules can be fixed to the motherboard with one or more screws 590 as shown in FIG. 5A. In this case, stress is caused by the rotation of the screw 590. To distribute stress across the mezzanine connector mounting pads, a tapped hole 590h may be formed in a line extending from the longitudinal center line of the pad arrangement pattern in each module.

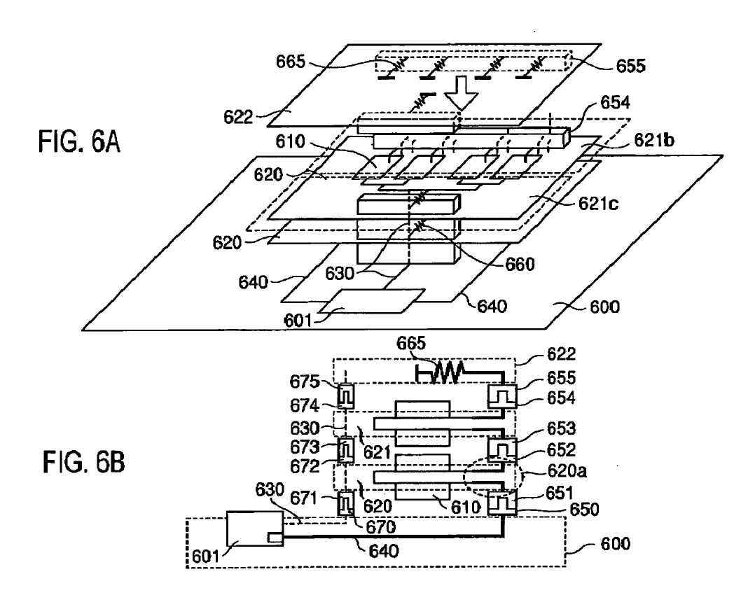

A memory system according to a fourth embodiment of the present invention will now be described below with reference to FIGS. 6A and 6B.

Referring to FIGS. 6A and 6B, the memory system has a motherboard 600 in which a memory controller 601 is mounted. In the motherboard 600, a command and address bus 630 and a data bus 640 are formed. Mezzanine connectors 670 and 650 are mounted on the motherboard 600. The mezzanine connector 670 is connected to the command and address bus 630. The mezzanine connector 650 is connected to the data bus 640. The memory system further includes memory modules 620 and 621 and a terminal module 622. A plurality of memories 610 are mounted in each of the memory modules 620 and 621.

The memory module 620 has mezzanine connectors 651 and 652 for the data bus 640 and those 671 and 672 for the command and address bus 630 on the lower and upper surfaces thereof. The memory module 621 has mezzanine connectors 653 and 654 for the data bus 640 and those 673 and 674 for the command and address bus 630 on the lower and upper surfaces. A stub resistor 660 is connected to each of the mezzanine connectors 671 and 673 for the command and address bus 630.

The terminal module 622 has a mezzanine connector 655 for the data bus 640 and a mezzanine connector 675 for the command and address bus 630 on the lower surface thereof and further includes termination resistors 665 connected to those connectors.

The mezzanine connectors 651 to 655 for the data bus 640 of the respective modules and those 670 to 675 for the command and address bus 630 are arranged on a pair of long parallel sides with a space therebetween. In other words, the mezzanine connectors 651 to 655 for the data bus 640 and those 670 to 675 for the command and address bus 630 are arranged close to the long opposed sides on the upper and lower surfaces of the respective modules. Consequently, data signals and command and address signals can be supplied to the memories in the different directions. In other words, in the memory module according to the present embodiment, a wiring region for the command and address bus does not cross over that for the data bus. Accordingly, the wiring region&, for example, regions 621b and 621c in the module 621 can be completely separated from each other, so that the longitudinal length of each module can be reduced and the flexibility of the wiring layout can be greatly increased. Thus, the length of signal wiring can be shortened. This leads to a reduction in area of the module and realization of higher data transfer rate.

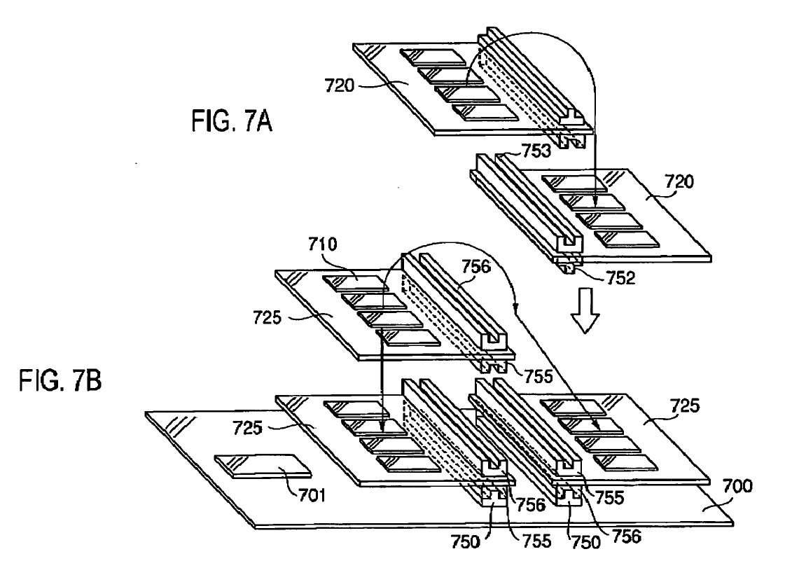

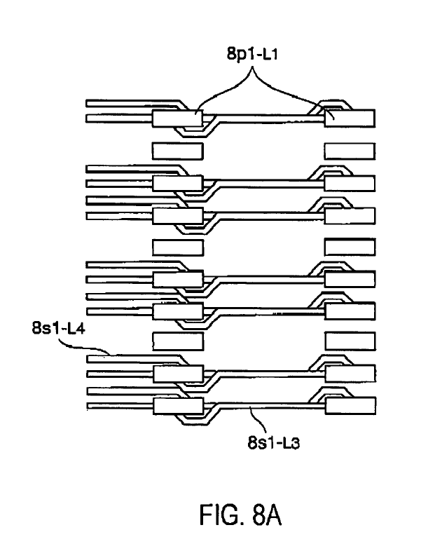

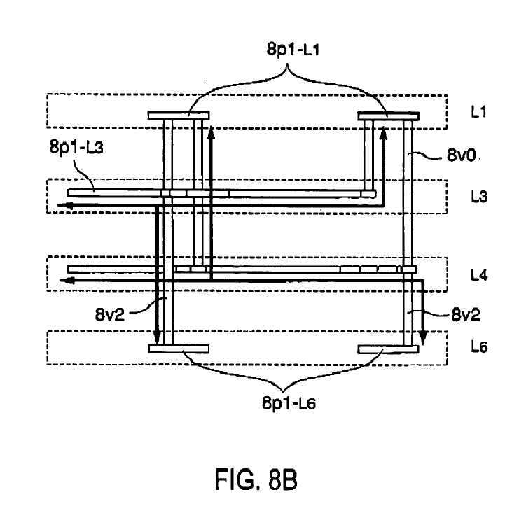

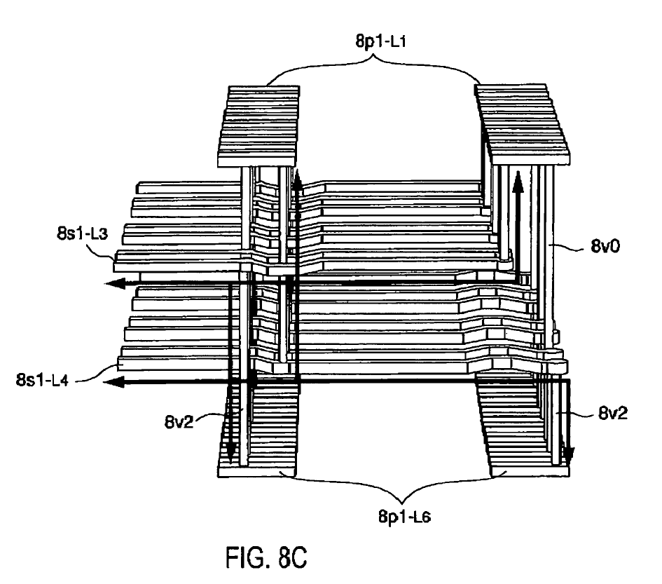

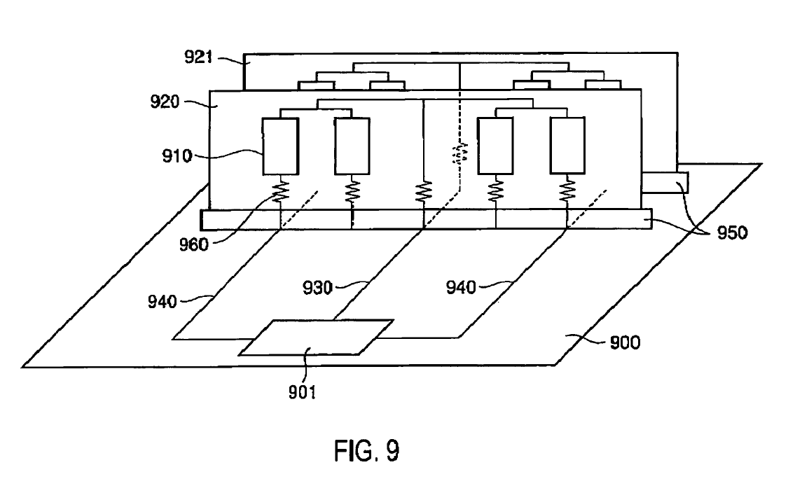

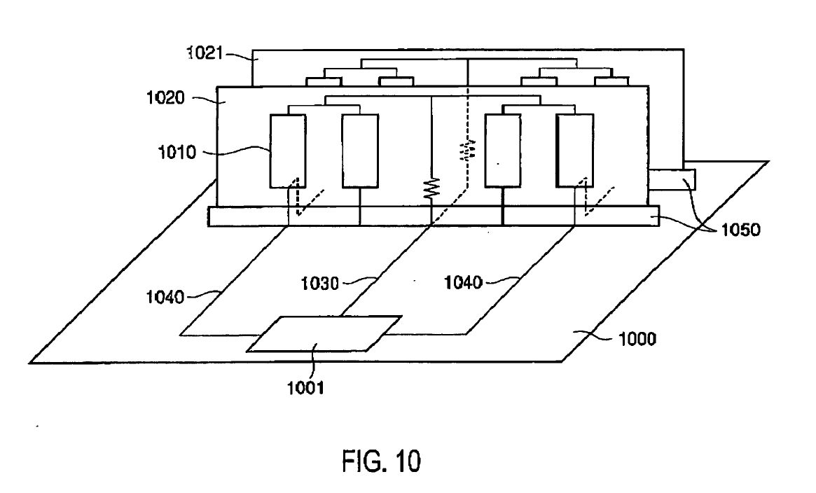

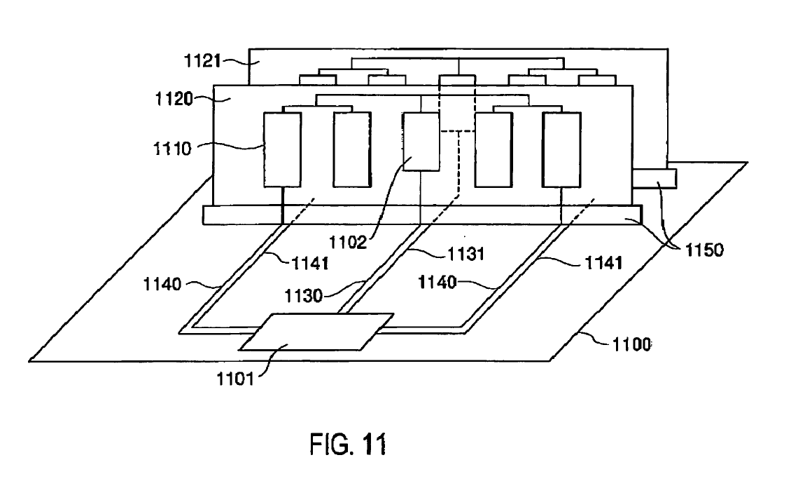

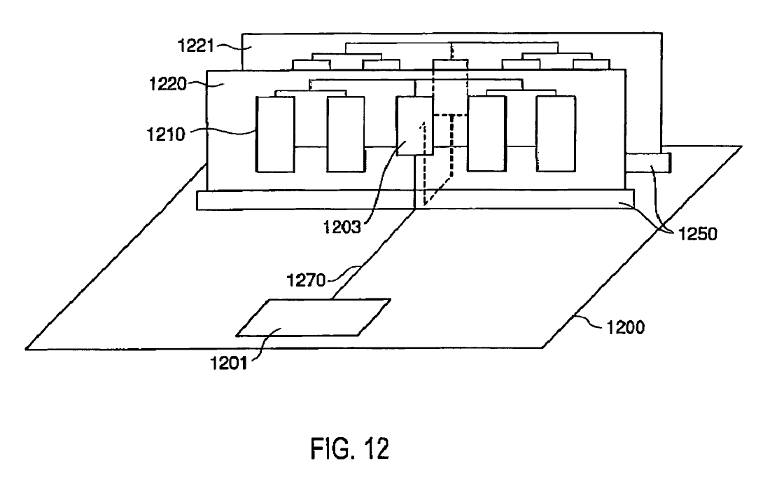

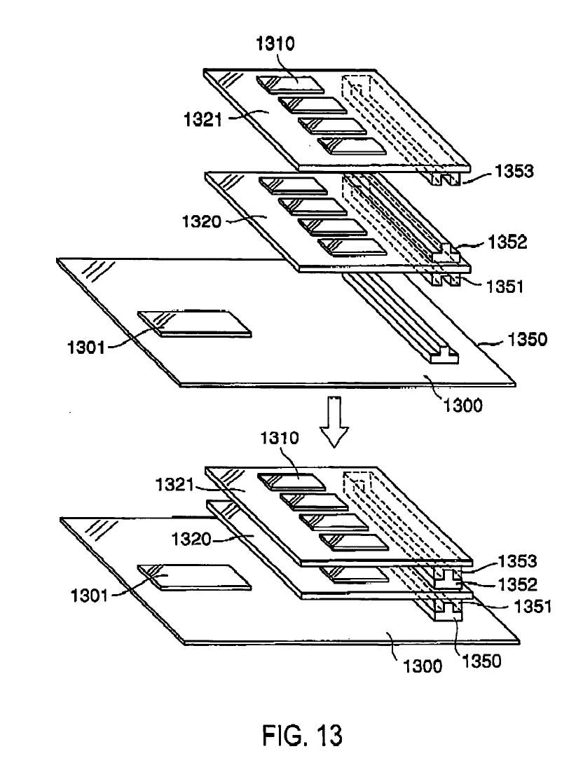

A memory system according to a fifth embodiment of the present invention will now be described below with reference to FIGS. 7 and 8A to 8C.

Referring to FIG. 7, two mezzanine connectors 750 of the same type (male type in this case) are arranged parallel to each other on a motherboard 700 in which a memory controller 701 is mounted.

Mezzanine connectors 755 and 756 of the same type (female type in this case) are attached to each memory module 725 having memories 710 such that the connectors correspond to each other on the upper and lower surfaces. Each of the mezzanine connectors 755 and 756 can be engaged with the mezzanine connector 750 on the motherboard 700. The internal wiring of each memory module 725 is arranged so that either of the mezzanine connectors 755 and 756 can be engaged with the mezzanine connector 750 on the motherboard 700 by rotating the memory module 725 by 180° about the axis along one longitudinal side, which the mezzanine connectors 755 and 756 are arranged close to.

FIG. 8A is a tope view of the wiring layout of the data bus in a region in the vicinity of the connectors in the memory module 725. FIG. 8B is a side view thereof and FIG. 8C is a perspective view thereof.

Referring to FIGS. 8A to 8C, regarding mezzanine connector mounting pads for signal, right pads of mounting pad 8p1-L1 on the upper surface are connected to left pads of mounting pads 8p1-L6 on the lower surface, respectively. Left pads of the mounting pads 8p1-L1 are connected to right pads of the mounting pads 8p1-L6, respectively. As for other mounting pads for power-supply/GND, the pads on the upper and lower surfaces are connected so as to correspond to each other.

According to the present embodiment, to realize the above-mentioned connection between the mounting pads, all or some of the pads for mounting a device or a mezzanine connector have a pad-n-via structure. Further, all or some of the vias are stacked blind vias and buried vias for connecting only specific layers.

With the above structure, the memory module 725 according to the present embodiment can be attached to the motherboard 700 such that one surface faces the motherboard 700 as shown in the lower left portion of FIG. 7. Further, the memory module 725 can also be mounted on the motherboard 700 such that the other surface faces the motherboard 700 as shown in the lower right portion of FIG. 7. In other words, the reversed memory module 725 can also be attached to the motherboard 700. The fact that the memory module 725 can be mounted on the motherboard 700 such that one surface faces the motherboard 700 means that the memory module 725 can be stacked on the memory module 720 (according to any one of the first to third embodiments) shown in the uppermost portion of FIG. 7, On the other hand, the reversed memory module 720 can be stacked on the memory module 725, which is mounted on the motherboard 700 such that the other surface faces the motherboard 700. As long as only one memory module 725 capable of being attached to either of the mezzanine connectors 750 on the motherboard 700 is provided, therefore, the memory module 720 can be stacked on the motherboard 700 through either mezzanine connector 750. In other words, it is unnecessary to provide different modules designed specifically for the two mezzanine connectors 750 on the motherboard 700, thus overcoming a disadvantage in that when many memory modules are stacked, the length of wiring between the memory controller and the bottom module extremely differs from that between the memory controller and the top module. In other words, the difference in length of wiring from the memory controller between the respective modules can be reduced, resulting in an increase in data transfer rate.

The present invention has been described with respect to the several embodiments. The present invention is not limited to the above embodiments. For example, the above embodiments of the present invention have been made with respect to a transfer mode of a data bus. A command and address bus can have any transfer mode unless data transfer rate of a memory system is limited. In other words, the transfer mode of the data bus according to the present invention can be applied to a memory system having a transfer mode of a command and address bus, which is different from those of the above embodiments. The above-mentioned embodiments can also be combined with each other. Further, the number of stacked modules is not limited to two or three according to the above embodiments. Four or more memory modules may be tacked. The number of memories in one surface of each memory module is not limited to four. Four or more or fewer memories may be mounted. Moreover, the number of mezzanine connectors mounted on one surface of each memory module is not limited to one or two. Three or more mezzanine connectors can be mounted. Further, the number of data bus channels in a memory system is not limited to one or two. Two or more channels can be arranged.

1. A memory system comprising:
a plurality of memory modules each of which a plurality of memories are mounted in;
a memory controller for controlling the memories;
a motherboard in which the memory controller is mounted; and
mezzanine connectors serving as means for electrically connecting the motherboard to be memory modules, wherein each memory module includes blind vias and buried vias.

2. The memory system according to claim 1, wherein
the blind vias and the buries vias include stacked blind vias and buried vias for connecting only specific layers so that the vias have no redundant portions in signal transmission routes and
at least some of a plurality of pads formed on the upper surface and/or the lower surface of each memory module are formed on the blind via*s or above or below the buried vias.

3. The memory system according to claim 1, wherein
the memory controller is connected to the memories via a plurality of resistance elements each serving as a stub resistor and a plurality of lines with stubs to transfer data therebetween.

4. The memory system according to claim 1, wherein
the memory controller is connected to the memories via a plurality of single-stroke lines with no stubs and the far end of each line is terminated by a termination resistor to transfer data therebetween.

5. The memory system according to claim 1, wherein
the memory controller is connected to each of the memories in a one-to-one relationship via a plurality of lines with no stubs to transfer data therebetween.

6. The memory system according to claim 1, wherein
a buffer is arranged in each of the memory modules, the memory controller is connected to the buffers via a plurality of single-stroke lines with no stubs to transfer data between the memory controller and the memories through the buffers.

7. The memory system according to claim 1, wherein
at least some of pads for mounting the mezzanine connectors are formed on the blind vias, or above or below the buried vias,
signal lines extending from the mezzanine connectors to the memories include the blind vias and/or the buried vias, and inner-layer wiring in each memory module.

8. The memory system according to claim 1, wherein
the mezzanine connectors include first connectors for a data bus and second connectors for a command and address bus, and
the first and second connectors are arranged close to the respective ends serving as opposite sides of each of the memory modules.

9. The memory system according to claim 1, wherein
one of the memory modules has two connectors of the same type as the mezzanine connectors, the two mezzanine connectors being arranged on the upper and lower surfaces of the memory module such that the connectors correspond to each other, and
internal wiring in the memory module is arranged so that either of the two mezzanine connectors of the same type is attachable to the motherboard by rotating the memory module about the axis along the longitudinal sides of the connectors by 180°.

10. The memory system according to claim 1, wherein
each of the memory modules has at least one tapped hole in a line extending from the longitudinal center line of an arrangement pattern of pads for mounting the mezzanine connectors.

11. The memory system according to claim 2, wherein
the memory controller is connected to the memories via a plurality of resistance elements each serving as a stub resistor and a plurality of lines with stubs to transfer data therebetween.

12. The memory system according to claim 2, wherein
the memory controller is connected to the memories via a plurality of single-stroke lines with no stubs and the far end of each line is terminated by a termination resistor to transfer data therebetween.

13. The memory system according to claim 2, wherein
the memory controller is connected to each of the memories in a one-to-one relationship via a plurality of lines with no stubs to transfer data therebetween.

14. The memory system according to claim 2, wherein
a buffer is arranged in each of the memory modules, the memory controller is connected to the buffers via a plurality of single-stroke lines with no stubs to transfer data between the memory controller and the memories through the buffers.

15. The memory system according to claim 2, wherein
the mezzanine connectors include first connectors for a data bus and second connectors for a command and address bus, and
the first and second connectors are arranged close to the respective ends serving as opposite sides of each of the memory modules.

16. The memory system according to claim 2, wherein
one of the memory modules has two connectors of the same type as the mezzanine connectors, the two mezzanine connectors being arranged on the upper and lower surfaces of the memory module such that the connectors correspond to each other, and
internal wiring in the memory module is arranged so that either of the two mezzanine connectors of the same type is attachable to the motherboard by rotating the memory module about the axis along the longitudinal sides of the connectors by 180°.

17. The memory system according to claim 2, wherein
each of the memory modules has at least one tapped hole in a line extending from the longitudinal center line of an arrangement pattern of pads for mounting the mezzanine connectors.

18. The memory system according to claim 3, wherein
first pads for mounting the stub resistors are formed in regions in the upper and lower surfaces of each memory module such that the regions correspond to each other,
the first pads and at least some of second pads for mounting the mezzanine connectors are formed on the blind vias, or above or below the buried vias, and
the first pads and the second pads are connected to each other through inner-layer wiring included in each memory module.

19. A memory module including a multilayer circuit board in which a plurality of memories are mounted, wherein
a pair of mezzanine connectors are arranged on the upper and lower surfaces of the multilayer circuit board, the connectors being electrically connected through the multilayer circuit board, and
signal routes, which electrically connect the pair of mezzanine connectors and the memories, include pads formed on the upper and lower surfaces of the multilayer circuit board, blind vias and buried vias formed on and/or close to the pads, and inner-layer wiring in the multilayer circuit board.

20. A memory system including the memory module according to claim 19.
